(19) United States
(12) Patent Application Publication
(10) Pub. No.: US 2019/0295447 A1
(43) Pub. Date: Sep. 26, 2019

(54) INSTALLING PRINTED MEDIA

(71) Applicant: Velcro BVBA, Deinze (BE)

(72) Inventors: Klaas Jan Stol, Barcelona (ES); Philippe MV Lecluyse, Sint-Martens-Latem (BE); Sophie Roets, Maldegem (BE); Ward Karel Gaby Verstraete, Harelbeke (BE)

(21) Appl. No.: 16/295,000

(22) Filed: Mar. 7, 2019

Related U.S. Application Data
(60) Provisional application No. 62/646,455, filed on Mar. 22, 2018.

(51) Int. Cl. G09F 15/00; B32B 5/02; B32B 27/12; G09F 3/08

(52) U.S. Cl. CPC G09F 15/0018; B32B 5/022; G09F 3/08; G09F 15/0062; B32B 27/12

(57) ABSTRACT

A printed media display system includes multiple patches each carrying discrete male touch fastening elements, the patches arranged in a pattern across a mounting surface, and print media in the form of a lightweight flexible sheet having a fastening side and a print side, the fastening side featuring engageable fibers of a non-woven spanning and engaging the multiple patches.

### TECHNICAL FIELD

This invention relates to display systems involving hook and loop fastening, and to methods of installing printed media to cover surfaces such as walls.

### BACKGROUND

Informational and decorative displays are often applied to walls and other surfaces. In many contexts it is desirable to change them seasonally, without damage to the underlying surface. Sometimes these displays are applied as multiple sheets of printed media, installed with aligned edges to form a continuous image across the sheets. Installation and removal of such sheets can require a certain level of skill, particularly when dealing with a surface cling type of adherence, as bubbles and creases can be difficult to avoid.

For ease of installation and removal it has been suggested to secure such display sheets by hook and loop engagement, such as by covering a wall surface with an engageable fibrous material and providing male touch fastener elements on the back surface of each sheet.

The invention focuses on improvements to display systems involving hook and loop fastening.

### SUMMARY

Various aspects of the invention feature a printed media display system with media mounting patches adhesively attached to a wall surface, and print media covering and releasably secured to the patches. The patches are arranged in a pattern in which portions of wall surface are exposed between adjacent patches, each patch comprising a flexible resin sheet carrying discrete male touch fastening elements arranged in a field extending across the patch, each male touch fastening element having a stem integrally molded with resin of the sheet, projecting outward and supporting a fiber-engageable head. The print media features a flexible sheet having a fastening side and a print side, the fastening side having engageable fibers in a fibrous field extending across a length and width of the flexible sheet, the fibers releasably engaged with the media mounting patches so as to display the print side.

According to a first aspect of the invention, the patches each have an area of at least 500 square centimeters, and wherein the patches are arranged in an array in which the hook patches together directly underlie a majority of area of the print media.

According to a second aspect of the invention, the patches are arranged such that opposing edges of any two adjacent patches are separated by a non-zero distance less than a width of either of the two adjacent patches.

According to a third aspect of the invention, the print media is constructed such that edges of the patches are visible through the print media, the patches arranged such that the pattern provides, in cooperation with an image printed on the print media, a visual effect.

According to a fourth aspect of the invention, the media mounting patches are sufficiently transparent that a color of the wall surface underneath the patches is visible through the patches.

According to a fifth aspect of the invention, the patches each includes a non-woven material permanently secured to and covering a side of the resin sheet opposite the male touch fastening elements, and adhesive encapsulating fibers of the non-woven material and adhering the patch to the wall surface.

Each of these aspects may be realized in embodiments that include various other features.

For example, in some embodiments, the resin sheet is sufficiently transparent that the non-woven material is visible through the resin sheet, and wherein the non-woven material is printed with an image or is of a color similar to a color of the wall surface.

In some cases, each patch is bounded by straight edges and has a minimum extent, between opposite edges in any direction, of at least 25 cm, preferably at least 40 cm.

In some applications the wall surface is curved and the patches, as adhered to the wall surface, follow curvature of the wall, and the print media, as engaged to the patches, follows the curvature of the wall. The wall is preferably curved only in one direction, and the patches are arranged such that the patches are farther apart in the curved direction than in a perpendicular direction.

In some cases, the print media is in the form of a single seamless panel covering the entire wall surface. In some cases, it includes one or more panels each extending across an entire vertical extent of the wall surface. In some cases, the print media includes multiple panels, with two of the panels having adjacent edges that overlie at least one of the patches.

Preferably, the pattern of patches includes at least one patch extending to each edge of the print media.

In some examples, the wall surface has a roughness not visible through the print media.

In some embodiments, the print media includes a non-woven material having an exposed surface comprised of the engageable fibers. In some cases, the non-woven material carries an image visible on the print side of the print media, the image printed directly on fibers of the non-woven material, and the non-woven material may be of greater loft on the fastening side than the print side.

The print side of the print media may be releasably engageable by touch fastener elements. In some cases, the system also includes flexible labels selectively and releasably securable to the print media, by engaging touch fasteners of the labels to fibers of the print media. The labels may each carry images visible with the label engaged to the print media.

In some other cases, the non-woven material is covered with a coating on the print side of the print media, the coating carrying a visible image.

Preferably, the patches have a total thickness, measured from the wall surface to an outer extent of the male touch fastener elements, of between 0.25 and 1.0 mm.

The male touch fastening elements are preferably arranged with a density of between 200 and 400 elements per square centimeter across the field, and each extends to an overall height of between 0.3 and 0.7 millimeters from a surface interconnecting the touch fastening elements.

The print media preferably has an overall basis weight of between 50 and 200 gsm.

The wall surface may be a surface of permanent structure, such as of a load-bearing wall of a building, or may be a surface of a free-standing display.

For some applications, the patches each have an area of at least 1000 square centimeters, preferably at least 1500 square centimeters.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows print media covering a curved wall.

FIG. 2 shows the wall with the print media removed.

FIG. 2A shows another patch arrangement.

FIG. 3 is an enlarged cross-section through an edge of a patch and a section of engaged print media.

FIG. 4 is an enlarged cross-sectional view of a second example of print media.

FIG. 5 shows a roll of print media.

FIG. 6 shows a stack of hook patches.

FIG. 7 is a cross-sectional view of an edge region of a hook patch with an associated release liner.

FIG. 8 is a perspective view of an assembled, free-standing display.

FIG. 9 shows the display with the print media removed.

FIG. 10 shows a frame of the display.

FIG. 11 is a cross-sectional view, taken along line 11-11 in FIG. 10.

Like reference symbols in the various drawings indicate like elements.

### DETAILED DESCRIPTION

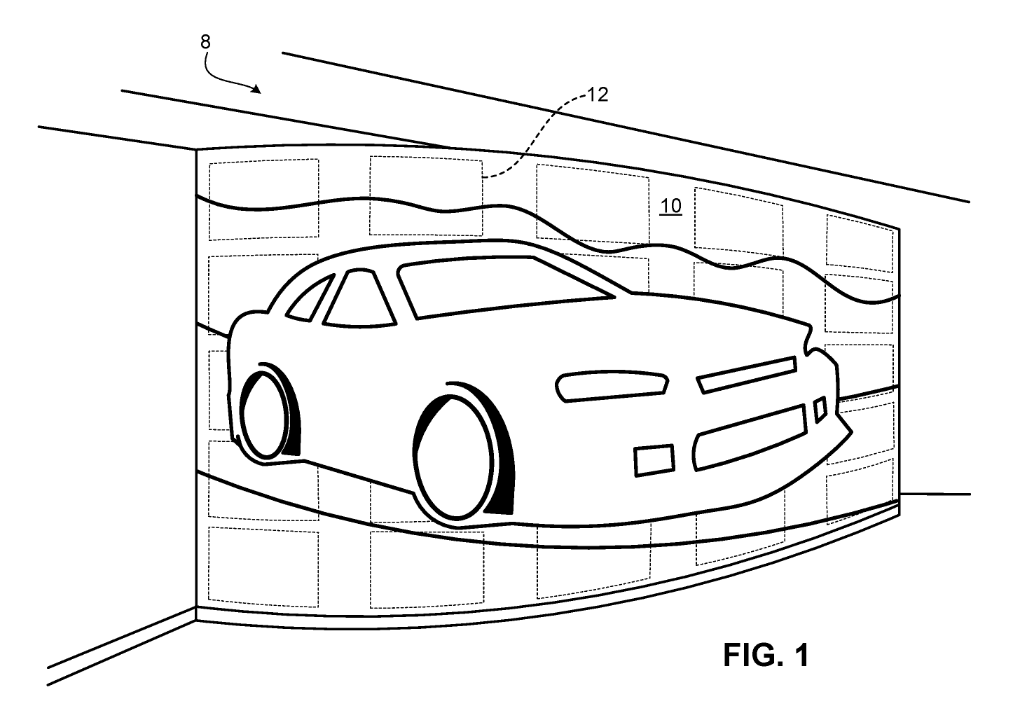

Referring first to FIG. 1, curved wall 8 is releasably covered by print media 10 in the form of a flexible sheet of material having a printed side facing outward, and a fastening side facing the wall. The printed side bears an image viewable from within the room. At least the fastening side is essentially covered with a web of hook-engageable fibers, such as in the form of a non-woven material extending across the extent of the sheet. In some examples, media 10 consists essentially of a light non-woven loop material printed on one side. Media is sufficiently dimensionally stable in its plane, and sufficiently flexible in bending out of its plane that it can be processed through commercially available printers as a continuous substrate and rolled for transport, and applied to the wall to follow the curvature of the wall. Two specific examples are discussed below, but for many typical applications the printed media preferably has a total basis weight of less than about 200 grams per square meter (gsm) and an overall thickness of less than about 1.5 millimeters. For some special applications, such as when thermal insulation or sound attenuation is desired, the print media may be formed from heavier and thicker non-woven materials, such as DIGI FLEX FR, available from CAPTIQS Dynamic Nonwovens of Belgium, with a basis weight of 300 gsm and a thickness of 2.2 mm. The width and length of the sheet will in some cases be two meters or more.

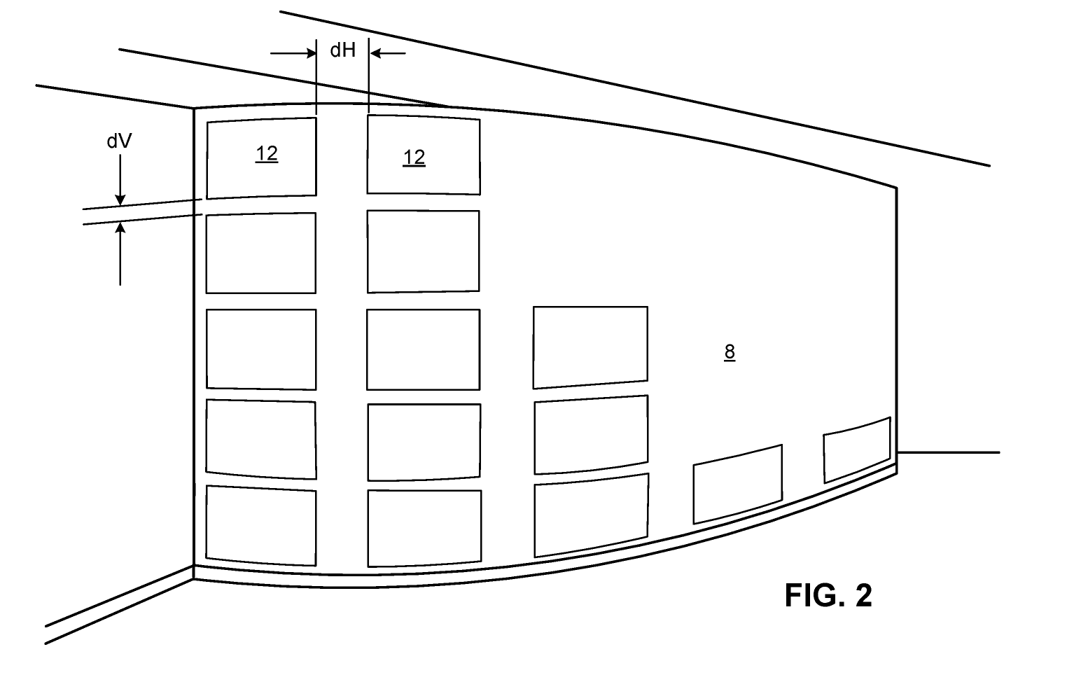

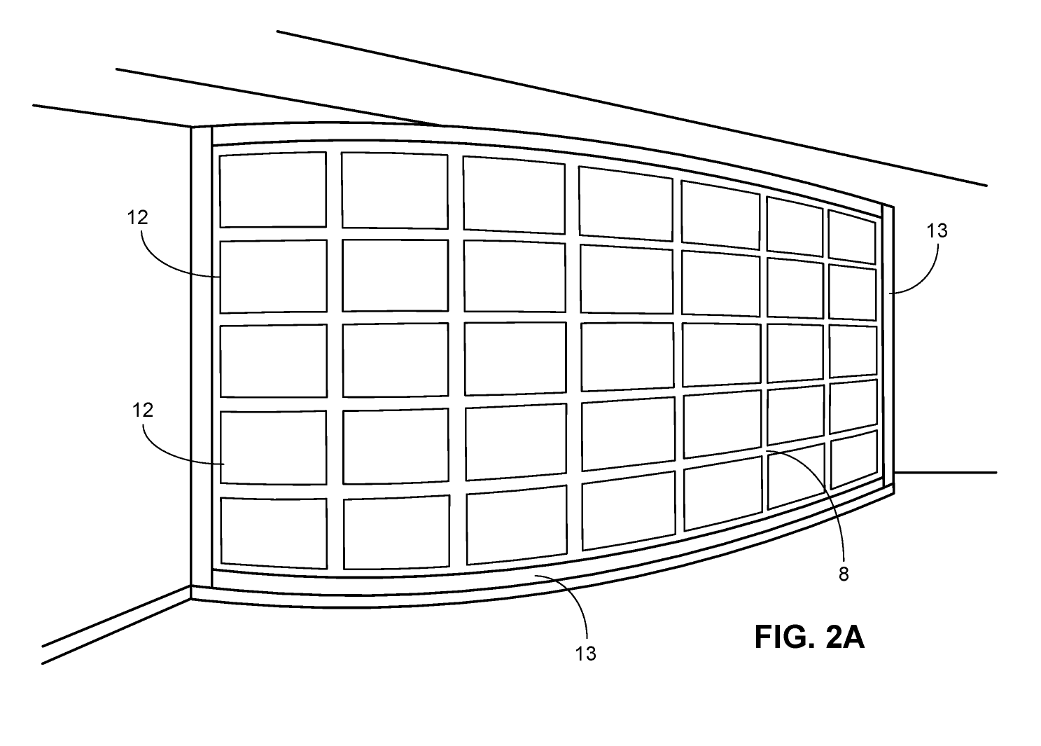

Referring also to FIG. 2, media 10 is held to the wall by multiple hook patches 12 adhered to the wall. The patches 12 are arranged in a pattern, such as in aligned rows and columns as illustrated, preferably opposing edges of any two adjacent patches separated by a distance less than a width of either of the two adjacent patches. Preferably each patch 12 is bounded by straight edges and has a minimum extent, between opposite edges in any direction, of at least 25 cm. It is also preferable that the patches 12 are sized and arranged to directly underlie a majority of the area of the print media. For example, in the pattern shown, each patch is a square of edge length 45 cm, having a patch area of 2025 cm². The patches are separated by a horizontal distance dH of 20 cm, and a vertical distance dV of only 10 cm. The gaps between patches help to distribute variations in tension and distortions, to avoid wrinkles or puckers. In this application, we found that keeping the horizontal spacing dH at or below 45 cm provided a desirable result. As will be discussed in more detail below, each media mounting patch 12 is a flexible resin sheet carrying discrete male touch fastening elements configured to releasably engage the fibers on the fastening side of the print media, to hold the print media in place on the wall. In this example each patch has four straight edges joined at square corners, and the patches of each row and column are aligned such that their edges are collinear. While the pattern includes exposed areas of wall surface, the pattern preferably includes patches that extend to each corner and edge of the print media, to secure the edges and corners.

In this example the print media 10 is a single seamless panel spanning the entire wall surface, including spanning an entire vertical extent of the wall surface from baseboard to ceiling, and an entire horizontal extent of the wall surface. If the print media is to be applied as a set of panels with an adjoining edge, such as a vertical edge, the patches 12 are arranged such that one row or column of the patches directly underlies the adjoining panel edge or seam, so that fastener elements of the row or column of patches engage fibers on both sides of the adjoining panel edge or seam.

In this example the print media 10 is partially transparent, such that the outlines of the hook patches 12 are somewhat visible through the print media and form a combined visual effect in combination with the image printed on the printed side of the media. While shown square or rectangular in this example, one or more of the patches can be shaped such that a slightly visible outline of the shaped patch provides a desirable ‘watermark’ on the print media. For example, the shaped patch may be in the shape of a product's or store's brand or logo. In other examples the print media is entirely opaque, such that the patches are not visible with the media mounted on the wall.

FIG. 2A shows an alternate arrangement of hook patches, with an array of spaced patches 12 covering a majority of the area to underlie the print media, but with a continuous band 13 of hook material, of the same constructions as the individual hook patches, extending about a periphery of the area to be covered by print media, such that the print media will be engaged to the wall without any significant engagement gaps around its perimeter. Band 13 may be formed as a series of abutting strips of material.

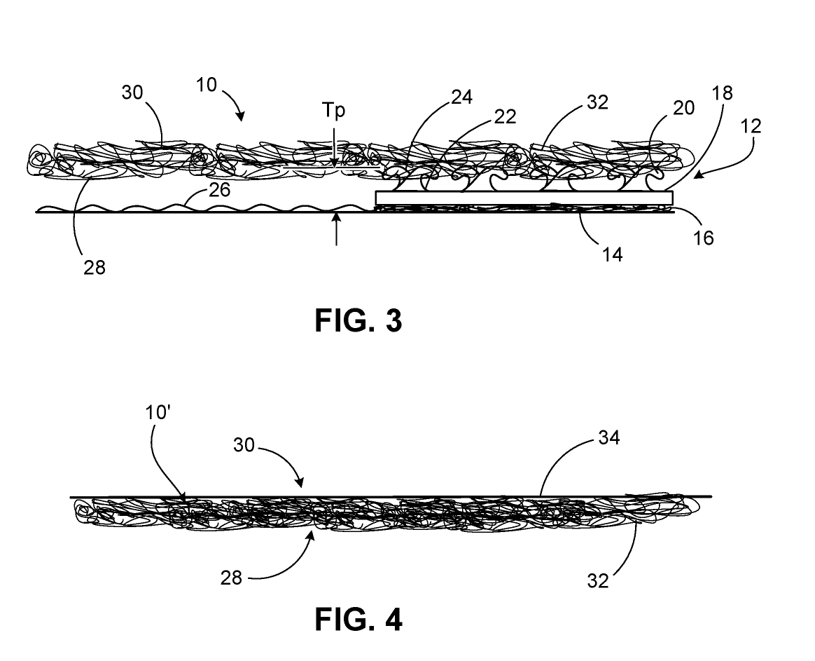

Referring next to FIG. 3, each patch 12 is adhered to the wall surface with a pressure-sensitive adhesive 14 embedded in a non-woven backing 16 of the patch. The adhesive may be a suitable hot-melt adhesive, for example, and should be selected to provide the desired adhesion to the wall surface. The patch has a thin resin base 18 and an array of male fastener elements 20, such as hooks, arranged in a field of rows and columns extending across the patch, each male touch fastening element 20 having a stem 22 integrally molded with resin of the sheet, projecting outward and supporting a fiber-engageable head 24. The base 18 may have a thickness of, for example, only 0.2 mm and the fastener elements themselves may only be about 0.4 mm in height, such that, including the non-woven backing and adhesive, the overall patch may extend a distance Tp of 0.7 mm from the wall surface (preferably between 0.25 and 1.0 mm). Given the extremely small size of the fastening elements, each 45 cm square patch may carry over 500,000 discrete fastener elements and the fastener elements themselves cause no visible effect at the printed surface of the print media. Moreover, the patches and the touch fastening engagement at the fastening side 28 of the print media are sufficiently flexible and accommodating to avoid any visible effect of asperities 26 or roughness of the wall surface at the printed side 30 of the print media.

In this example the print media 10 is a polyester non-woven material 32, formed by needling and thermal bonding to have a basis weight of 150 gsm and a pile thickness (tested at 2 kPa) of only 1.0 mm. Such a material is available in roll form from CAPTIQS as product CBC4-MW-150W. The print media may be formed to have a greater loft on its fastening side than on its printed side. Other suitable non-wovens for the print media include loop material sold by VELCRO USA Inc. of Manchester, N.H., under the designation FNL-255 or FNL-264. FNL-255 has a basis weight of around 90 gsm, while FNL-264 has as a basis weight of only around 54 gsm, placing them in the category of extremely light non-woven materials. Other acceptable non-wovens can be fashioned as described in U.S. Pat. No. 6,329,016 or U.S. patent application Ser. No. 14/725,420, the entire contents of both of which are incorporated fully by reference.

The patch 12 is cut from a continuous length of wide hook tape formed, for example, by the in situ molding/lamination process described in U.S. Pat. No. 5,260,015, the entire contents of which are incorporated herein by reference. In such a process, the non-woven backing 16 is introduced to a nip between two calender rolls, one of which is a mold roll defining closed cavities in which the hooks are molded, while the base 18 is formed in the nip between the rolls. Pressure in the nip partially embeds the non-woven backing into the resin before it solidifies, such that fibers of the non-woven are encapsulated within the resin of the base, leaving other fibers exposed for encapsulation by the adhesive 14. In this way the non-woven backing is said to be in situ laminated, or directly laminated (i.e., without a separate adhesive material) to the base. The non-woven backing may be, for example, a 60 gsm SMS thermos-bonded polypropylene material available from UNION INDUSTRIES as product D6003PHW. The male fastener elements 20 may be J-hooks as shown, with hooks of alternating columns overhanging in opposite directions, or may be mushroom-type fasteners with heads overhanging stems in essentially all directions, or palm-tree hooks having heads overhanging in two opposite directions. The fastening elements may essentially be any shape designed to snag the fibers of the print media to hold the print media to the wall, while being sufficiently small and densely arranged that discrete fastener elements do not cause visible effects on the printed side of the print media. The male fastener elements and base can be formed of thermoplastic material, such as polyethylene or polypropylene. A suitable size of fastener element is the CFM-29 hook, available in different materials and distributions from VELCRO USA Inc. The hooks 20 may be, for example, of less than about 0.5 mm in height and may extend from a base of less than about 0.2 mm in thickness.

In the example of FIG. 3, ink or dye is deposited directly on fibers of the print media, on its printed side, to form a visible image. Even printed, the print media retains a certain porosity and the mechanical attributes of the print media, such as its dimensional stability, elasticity, etc., are determined by the non-woven itself. We find that images printed directly on the non-woven material can be of suitable clarity while retaining a pleasing warmth and softness of tone.

FIG. 4 shows an alternate print media 10′ that includes a coating 34 on its printed side 30. The coating is deposited on the surface of the non-woven material 32, and the image is formed from ink or dye printed on the surface of the coating. Coating can be sufficiently continuous that the resulting print media 10′ has essentially no permeability to air, and the mechanical attributes of the print media are a function of the coating properties. The coating may be, for example, an acrylic coating applied as a mixture of aqueous dispersed acrylic binders whitened with titanium dioxide, solidified to form a coating with a basis weight of 110 gsm and encapsulating surface fibers of the non-woven material 32. The non-woven material 32 may be the same as in the example of FIG. 3. We find that images printed directly on such a non-porous coating can exhibit improved sheen and a pleasing finish.

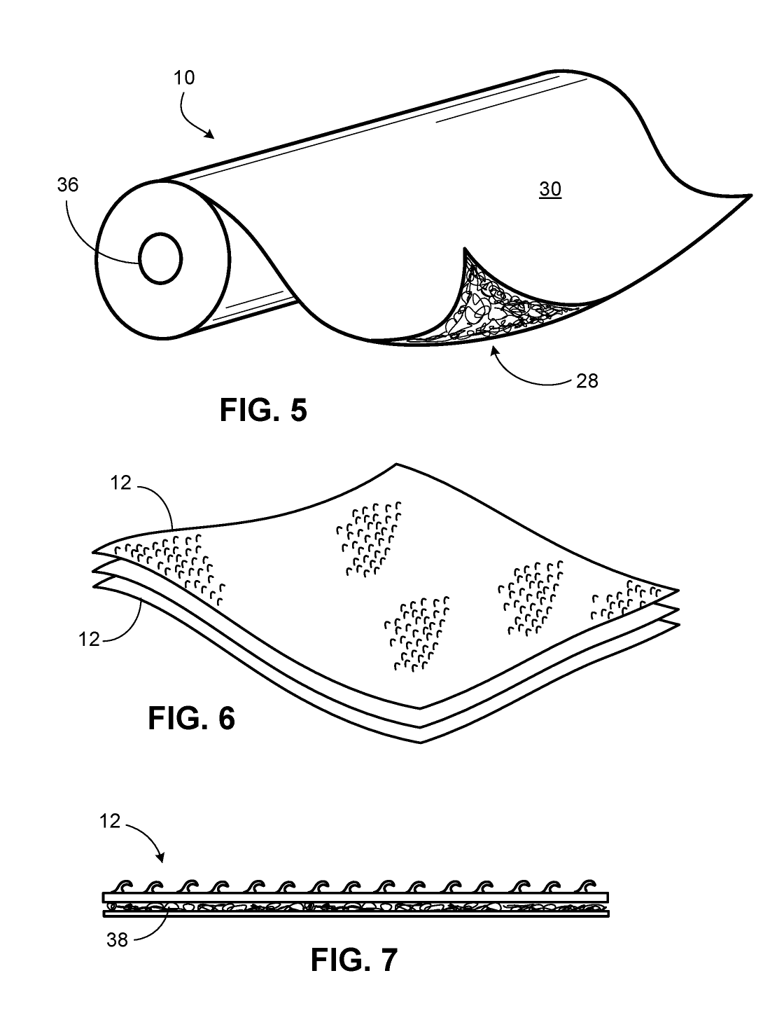

Whether coated or uncoated, the printed print media 10 can be transported to the installation site in roll form, rolled on a spool 36 as shown in FIG. 5. The roll can be of a length equal to the height of the wall to be covered, for example, and installed progressively from one side edge of the wall across the wall surface, unrolling from the spool as the print media is secured to the hook patches. In this case, the roll may be of a length of at least two, or perhaps three, meters, and the rolled media may have an overall length, in the rolled direction, of five meters or more. Alternatively, the print media can be installed in vertical courses, preprinted such that the printed image extends across adjacent edges or seams between courses. In this case, the roll may be only one meter or less in length, and the rolled media may be two to three meters long in the rolled direction. The print media can be formed sufficiently dimensionally stable to avoid excessive stretching during installation, particularly in seamed applications. However, in some cases a small amount of elasticity can help to enhance the engagement between hooks and fibers, by slightly stretching the media as it is applied. Such elasticity should not be so much that the resulting image is visibly distorted. The printed surface of the printed media 10 carries an image formed by a dye or ink or some other colorant applied to the surface of the media, whether coated or uncoated. The ink can be applied by known print methods, such as screen, sublimation transfer or ink jet printing. The dimensional stability and flexibility of media 10 enable continuous, full width ink jet printing on a moving conveyor, such as on a LARIO printer available from MS Printing in Milan, Italy, for example. The media may be prepared and printed in very wide format and then slit into desired widths and either cut to discrete lengths or spooled for storage and shipment.

It can be helpful to installation in some applications to configure the male fastener elements of the patches and the print media such that the system exhibits a Wrinkle Propagation Coefficient (WPC) of between 12 and 25, and in some particular cases is between 15 and 25. Such a coefficient is described in pending U.S. patent application Ser. No. 15/068,802 and published as US 2017/0259603A1, the contents of which with respect to WPC, Small Deformation Shear Hysteresis (SDSH), bend rigidity and peel strength, and the system parameters affecting such variables, are incorporated herein by reference.

Referring next to FIGS. 6 and 7, the patches 12 can be transported as a stack of flexible panels. Each patch is sufficiently flexible that it can be rolled, or in some cases even folded. As seen in FIG. 7, each patch is provided with a release liner 38 covering the adhesive on the back surface of the patch and preventing adherence until the patch is to be applied to the wall. For installation, the release liners 38 are removed and the patches positioned and pressed against the wall surface to form the desired pattern, such as the one shown in FIG. 2. The flexibility of the patches allow them to conform to the curvature of the wall, which in the illustrated example has a curvature in a horizontal direction that is greater than curvature in a vertical direction. The wall in FIG. 2 has zero curvature in a vertical direction. The patches 12 in FIG. 2 are closer together in the vertical direction than in the horizontal direction. The print media, as engaged to the patches, follows the curvature of the wall.

With the patches installed on the wall, print media 10 may be installed, removed, and replaced with other print media, without disturbing the patches. The patches thus become a semi-permanent feature of the wall, although the adhesive is preferably such that they are removable without damaging the wall surface. Thus, the wall is readily reconfigured to different images, advertisements, promotions, themes, etc. The patches may be arranged in a visually appealing pattern to themselves provide a decorative effect in the absence of print media. To minimize the visibility of the patches in the absence of print media, the patch bases and fastener elements may be molded of a transparent resin, and the non-woven backing and adhesive of the patches may also be of non-opaque materials, such that the color or pattern of the wall surface is visible through the installed patches. Alternatively, the resin of the base and fastener elements of the patch may be transparent while the non-woven backing is printed with an image, such as a brand or logo, visible with the patch installed, or dyed a color similar to the wall color.

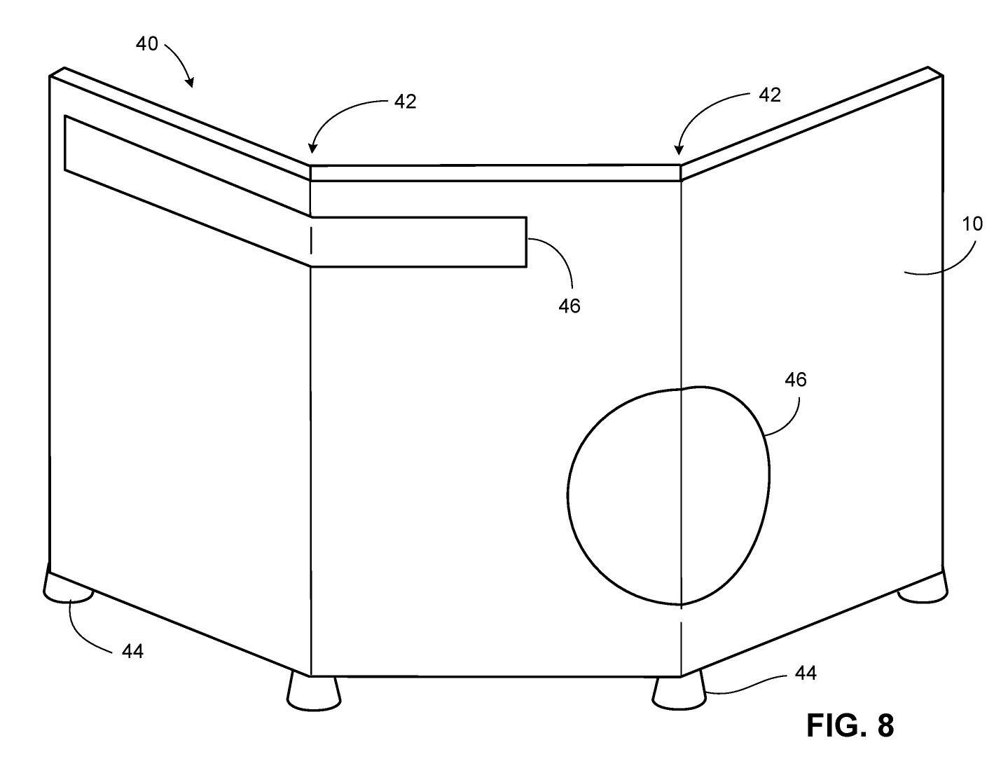

Referring next to FIG. 8, portable, free-standing display 40 has multiple flat, vertical panels connected at vertical hinges 42 and supported on feet 44. This example has three panels connected at two hinges, but other configurations are contemplated. Such displays are used, for example, at trade shows and as temporary walls between workspaces. In this case the display presents an image that spans multiple panels and crosses hinges. The image is printed on print media 10 releasably secured to an underlying surface carrying male touch fastener elements. Because the print media is removable, the display can be readily reconfigured to present different images. In this example, the print media 10 is of the form discussed above with respect to FIG. 3, in which the printed surface is fibrous and permeable, and remains engageable. This allows labels 46 to be releasably secured to the surface of the print media, each label having an array of male touch fastening elements on its back surface that releasably engage the printed fibers of the print media. The labels may themselves bear images that overlay and combine with the image printed on the print media, to provide a desired visual effect. The labels may be semi-opaque, or opaque. Thus, the display may be both reconfigurable and interactive. The labels may have fibrous outer surfaces that are engageable with yet other labels, so that multiple layering of surfaces is possible, for the impression of depth.

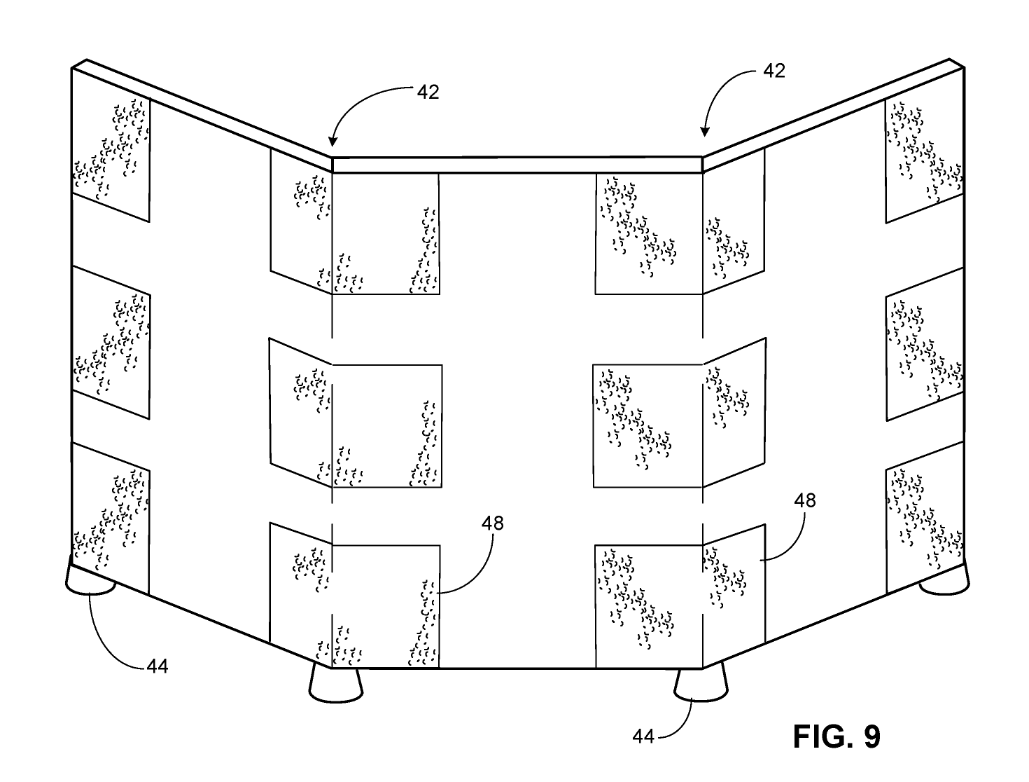

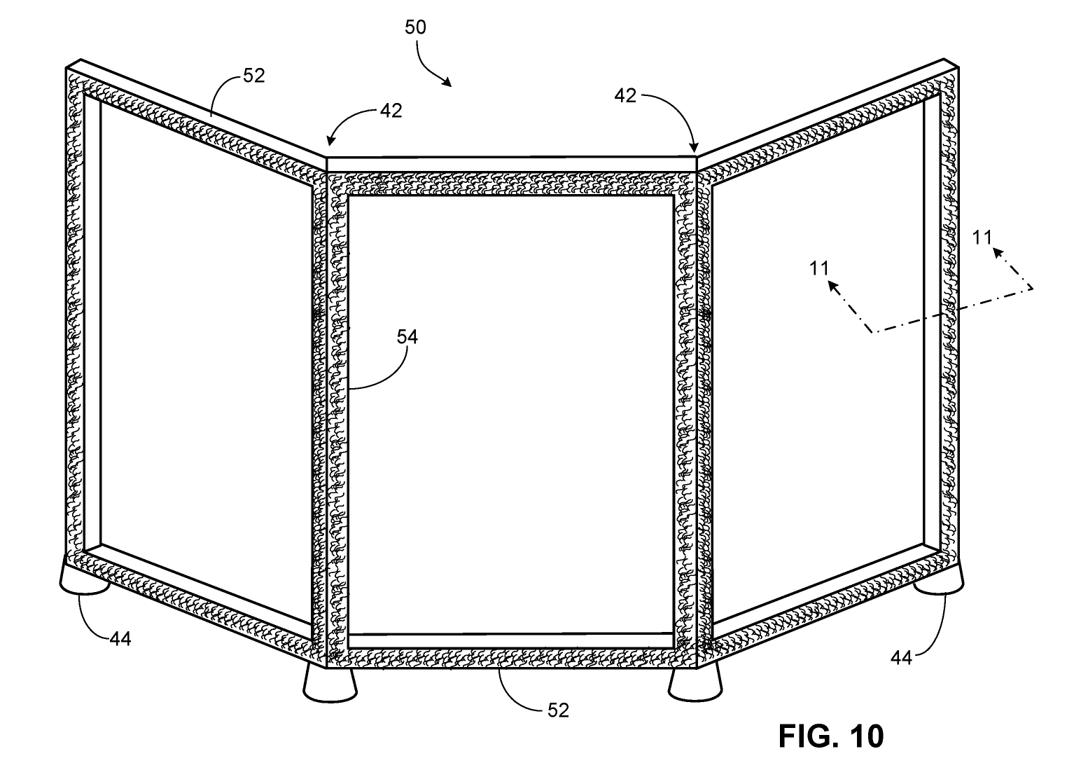

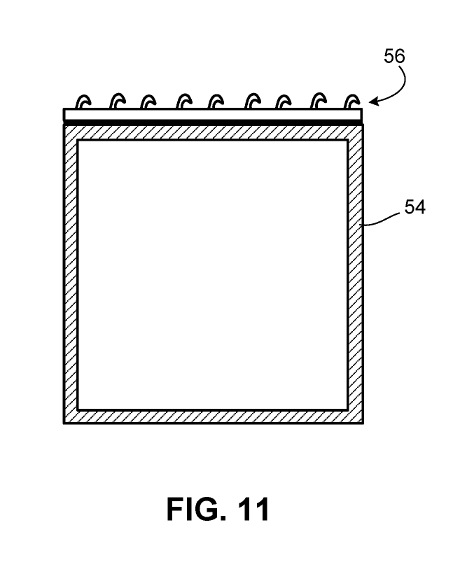

Referring to FIG. 9, the surface behind the print media has patches or areas 48 of fastener elements that releasably engage fibers of the fastening side of the printed media. As shown, the patches extend to the edges of the display but do not cover the entire display surface, leaving smooth surfaces between the patches. Some patches 48 span each hinge 42. The surface bearing the fastener element patches may itself be a flexible membrane, such as a vinyl sheet, that is unrolled and releasably fixed to a frame of the display during assembly, such as by more touch fasteners. Referring to FIG. 10, frame 50 has rigid horizontal links 52 and rigid vertical links 54, joined at appropriate joints to form a stable structure. Each panel of the assembly is framed by links surrounding an aperture that is eventually covered by the hook surface and then the print media. The hinges 42 of the frame are pivotable to reposition the frame in multiple orientations. Referring also to FIG. 11, each link carries, on a front side of the frame, male touch fastener elements, such as of industrial-grade hook tape 54 adhered to the surface of the link. The panel carrying the hook patches has corresponding loop fasteners positioned to engage the frame fasteners to hold the panel securely in place during use.

While a number of examples have been described for illustration purposes, the foregoing description is not intended to limit the scope of the invention, which is defined by the scope of the appended claims. There are and will be other examples and modifications within the scope of the following claims.

What is claimed is:

1. A printed media display system, comprising
media mounting patches adhesively attached to a wall surface and arranged in a pattern in which portions of wall surface are exposed between adjacent patches, each patch comprising a flexible resin sheet carrying discrete male touch fastening elements arranged in a field extending across the patch, each male touch fastening element having a stem integrally molded with resin of the sheet, projecting outward and supporting a fiber-engageable head; and
print media covering and releasably secured to the patches, the print media comprising a flexible sheet having a fastening side and a print side, the fastening side having engageable fibers in a fibrous field extending across a length and width of the flexible sheet, the fibers releasably engaged with the media mounting patches so as to display the print side;
wherein the patches are arranged such that opposing edges of any two adjacent patches are separated by a non-zero distance less than a width of either of the two adjacent patches.

2. The printed media display system of claim 1, wherein the media mounting patches are sufficiently transparent that a color of the wall surface underneath the patches is visible through the patches.

3. The printed media display system of claim 1, wherein the resin sheet is sufficiently transparent that the non-woven material is visible through the resin sheet, and wherein the non-woven material is printed with an image or is of a color similar to a color of the wall surface.

4. The printed media display system of claim 1, wherein each patch is bounded by straight edges and has a minimum extent, between opposite edges in any direction, of at least 25 cm.

5. The printed media display system of claim 1, wherein the wall surface is curved in one direction and the patches, as adhered to the wall surface, follow curvature of the wall, and the print media, as engaged to the patches, follows the curvature of the wall, the patches being arranged such that the patches are farther apart in the curved direction than in a perpendicular direction.

6. The printed media display system of claim 1, wherein the print media is in the form of a single seamless panel covering the entire wall surface.

7. The printed media display system of claim 1, wherein the print media comprises multiple panels, two of the panels having adjacent edges that overlie at least one of the patches.

8. The printed media display system of claim 1, wherein the pattern of patches includes at least one patch extending to each edge of the print media.

9. The printed media display system of claim 1, wherein the print media comprises a non-woven material that carries an image visible on the print side of the print media, the image printed directly on fibers of the non-woven material.

10. The printed media display system of claim 9, wherein the print side of the print media is releasably engageable by touch fastener elements.

11. The printed media display system of claim 10, further comprising flexible labels selectively and releasably securable to the print media, by engaging touch fasteners of the labels to fibers of the print media.

12. The printed media display system of claim 11, wherein the labels each carry images visible with the label engaged to the print media.

13. A printed media display system, comprising
media mounting patches adhesively attached to a wall surface and arranged in a pattern in which portions of wall surface are exposed between adjacent patches, each patch comprising a flexible resin sheet carrying discrete male touch fastening elements arranged in a field extending across the patch, each male touch fastening element having a stem integrally molded with resin of the sheet, projecting outward and supporting a fiber-engageable head; and
print media covering and releasably secured to the patches, the print media comprising a flexible sheet having a fastening side and a print side, the fastening side having engageable fibers in a fibrous field extending across a length and width of the flexible sheet, the fibers releasably engaged with the media mounting patches so as to display the print side;
wherein the patches each further comprises:
a non-woven material permanently secured to and covering a side of the resin sheet opposite the male touch fastening elements; and
adhesive encapsulating fibers of the non-woven material and adhering the patch to the wall surface.

14. The printed media display system of claim 13, wherein each patch is bounded by straight edges and has a minimum extent, between opposite edges in any direction, of at least 25 cm.

15. The printed media display system of claim 13, wherein the print media comprises multiple panels, two of the panels having adjacent edges that overlie at least one of the patches.

16. The printed media display system of claim 13, wherein the pattern of patches includes at least one patch extending to each edge of the print media.

17. The printed media display system of claim 13, wherein the print media comprises a non-woven material that carries an image visible on the print side of the print media, the image printed directly on fibers of the non-woven material.

18. A printed media display system, comprising
media mounting patches adhesively attached to a wall surface and arranged in a pattern in which portions of wall surface are exposed between adjacent patches, each patch comprising a flexible resin sheet carrying discrete male touch fastening elements arranged in a field extending across the patch, each male touch fastening element having a stem integrally molded with resin of the sheet, projecting outward and supporting a fiber-engageable head; and
print media covering and releasably secured to the patches, the print media comprising a flexible sheet having a fastening side and a print side, the fastening side having engageable fibers in a fibrous field extending across a length and width of the flexible sheet, the fibers releasably engaged with the media mounting patches so as to display the print side;
wherein the patches each have an area of at least 500 square centimeters, and wherein the patches are arranged in an array in which the hook patches together directly underlie a majority of area of the print media.

19. The printed media display system of claim 18, wherein the print media comprises multiple panels, two of the panels having adjacent edges that overlie at least one of the patches.

20. The printed media display system of claim 18, wherein the pattern of patches includes at least one patch extending to each edge of the print media.
